(19) United States
(12) Patent Application Publication
(10) Pub. No.: US 2018/0126785 A1
(43) Pub. Date: May 10, 2018

(54) Tire Comprising Working Layers Formed by Individual Wires

(71) Applicant: COMPAGNIE GENERALE DES ETABLISSEMENTS MICHELIN, Clermont-Ferrand (FR)

(72) Inventors: Claudia NAVARRO-LOSADA, Clermont-Ferrand Cedex 9 (FR); Jean-François PARMENTIER, Clermont-Ferrand Cedex 9 (FR); Vincent MARTIN, Clermont-Ferrand Cedex 9 (FR); Aurore LARDJANE, Clermont-Ferrand Cedex 9 (FR)

(21) Appl. No.: 15/574,977

(22) PCT Filed: May 11, 2016
(86) PCT No.: PCT/EP2016/060596

§ 371 Date: Nov. 17, 2017

(30) Foreign Application Priority Data
May 18, 2015 (FR) 1554392

(51) Int. Cl. B60C 9/20

(52) U.S. Cl. CPC B60C 9/20; B60C 2009/2016; B60C 2009/2019; B60C 2009/2038; B60C 2009/2077; B60C 2200/06; B60C 2009/2064

(57) ABSTRACT

Tire comprising a crown reinforcement formed of three working layers having between ends thereof two layers of rubber compound Ci. Thickness of the three working layers is <5 mm with individual metal wires as reinforcing elements of diameter <0.50 mm and a distance therebetween being strictly <1 mm. The axial width of each working layer is >60% that of the tread. Distance dᵢ between two working layers separated by a layer of rubber compound Ci and measured at the end of the axially narrowest working layer in contact therewith is such that 0.5<dᵢ<2.5 mm, and, in a meridian plane, the thickness of at least one layer of rubber compound Ci is substantially constant over the axial width between the axially inner end of a layer of rubber compound Ci and the end of the axially narrowest working layer in contact therewith.

The present invention relates to a tire having a radial carcass reinforcement, and more particularly a tire intended for fitting to vehicles that carry heavy loads, such as lorries, tractors, trailers or buses, for example.

In general, in tires for heavy-goods vehicles, the carcass reinforcement is anchored on each side in the bead region and is surmounted radially by a crown reinforcement made up of at least two superposed layers formed of wires or cords which are parallel within each layer and crossed from one layer to the next, making angles of between 10° and 45° with the circumferential direction. The said working layers that form the working reinforcement may furthermore be covered with at least one layer, referred to as a protective layer, formed of reinforcing elements which are advantageously metallic and extensible and referred to as elastic reinforcing elements. It may also comprise a layer of metal wires or cords having low extensibility, forming an angle of between 45° and 90° with the circumferential direction, this ply, referred to as the triangulation ply, being located radially between the carcass reinforcement and the first crown ply, referred to as the working ply, formed of parallel wires or cords lying at angles not exceeding 45° in terms of absolute value. The triangulation ply forms a triangulated reinforcement with at least the said working ply, this reinforcement having little deformation under the various stresses to which it is subjected, the triangulation ply essentially serving to absorb the transverse compressive forces which is the object of all the reinforcing elements in the crown area of the tire.

Cords are said to be inextensible when the said cords, under a tensile force equal to 10% of the breaking force, exhibit a relative elongation of at most equal to 0.2%.

Cords are said to be elastic when the said cords have a relative elongation of at least equal to 3% under a tensile load equal to the breaking load, with a maximum tangent modulus of less than 150 GPa.

Circumferential reinforcing elements are reinforcing elements which form angles with the circumferential direction in the range +2.5°, −2.5° around 0°.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction which intersects the axis of rotation of the tire and is perpendicular thereto.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

For metal wires or cords, force at break (maximum load in N), breaking strength (in MPa) and elongation at break (total elongation in %) are measured under tension in accordance with standard ISO 6892, 1984.

As regards the rubber compositions, the measurements of modulus are carried out under tension according to standard AFNOR-NFT-46002 of September 1988: the nominal secant modulus (or apparent stress, in MPa) at 10% elongation is measured in second elongation (i.e., after an accommodation cycle) (normal conditions of temperature and hygrometry according to standard AFNOR-NFT-40101 of December 1979).

Certain present-day tires, referred to as “road tires”, are intended to run at high average speeds and over increasingly long journeys, because of improvements to the road network and the growth of motorway networks worldwide. The combined conditions under which such a tire is called upon to run without any doubt makes possible an increase in the number of miles travelled, the wear on the tire being reduced. This increase in life in terms of distance covered, combined with the fact that such conditions of use are likely, under heavy load, to result in relatively high crown temperatures, dictates the need for an at least proportional increase in the durability of the crown reinforcement of the tires.

This is because stresses are present in the crown reinforcement; more particularly, there are shear stresses between the crown layers which, in the case of an excessive rise in the operating temperature at the ends of the axially shortest crown layer, result in the appearance and propagation of cracks in the rubber at the said ends. The same problem exists in the case of edges of two layers of reinforcing elements, the said other layer not necessarily being radially adjacent to the first layer.

In order to improve the endurance of the crown reinforcement of the tires, the French application FR 2 728 510 proposes arranging, on the one hand, between the carcass reinforcement and the crown reinforcement working ply that is radially closest to the axis of rotation, an axially continuous ply which is formed of inextensible metal cords that form an angle at least equal to 60° with the circumferential direction and of which the axial width is at least equal to the axial width of the shortest working crown ply and, on the other hand, between the two working crown plies, an additional ply formed of metal elements that are oriented substantially parallel to the circumferential direction.

In addition, French application WO 99/24269 notably proposes, on each side of the equatorial plane and in the immediate axial continuation of the additional ply of reinforcing elements substantially parallel to the circumferential direction, that the two working crown plies formed of reinforcing elements crossed from one ply to the next be coupled over a certain axial distance and then uncoupled using profiled elements of rubber compound over at least the remainder of the width that the said two working plies have in common.

The layer of circumferential reinforcing elements is usually formed by at least one metal cord wound to form a turn of which the angle of lay with respect to the circumferential direction is less than 8°. The cords initially manufactured are coated with a rubber compound before being laid. This rubber compound will then penetrate the cord under the effect of the pressure and temperature during the vulcanizing of the tire.

The results thus obtained in terms of endurance and wear in the case of prolonged road running at high speed are usually satisfactory. However, it would seem that, under certain running conditions, certain tires sometimes exhibit more pronounced wear on a part of their tread. This phenomenon is accentuated when the width of the tread increases.

Moreover, whatever the envisaged solutions such as those set out above, the presence of a layer of additional reinforcing elements results in a greater mass of the tire and higher tire manufacturing costs.

Document WO 10/069676 proposes a layer of circumferential reinforcing elements distributed at a variable spacing. Depending on the spacings chosen, more widely spaced in the central and intermediate parts of the layer of circumferential reinforcing elements, it is possible to create tires that have satisfactory performance in terms of endurance with improved performance in terms of wear. Moreover, compared with a tire comprising a layer of circumferential reinforcing elements distributed at a constant spacing, it is possible to reduce the mass and cost of such tires, even though it is necessary to make up for the absence of reinforcing elements by using masses of polymer.

It is an aim of the invention to provide tires for “heavy goods” vehicles in which the performance in terms of endurance and wear is retained, or improved, for road use, whatever the conditions of use, and in which the mass and cost of manufacture are reduced compared with those of the tires described above.

This objective is achieved according to the invention by a tire having a radial carcass reinforcement for a vehicle of the heavy duty type comprising a crown reinforcement comprising at least three working crown layers of reinforcing elements, crossed from one layer to the other, making with the circumferential direction angles of between 10° and 45°, which is itself capped radially by a tread, the said tread being connected to two beads by two sidewalls, at least two layers Ci of rubber compound being arranged between the ends of the said at least three working crown layers, in a meridian plane, the thickness of the said at least three working crown layers, measured in the equatorial plane, being less than 5 mm, the reinforcing elements of the said at least three working crown layers being individual metal wires of diameter less than 0.50 mm, the distance between the reinforcing elements, measured along the normal to the direction of the mean line of the wire, being strictly less than 1 mm, the axial width of each of the said at least three working crown layers being greater than 60% of the axial width of the tread, at least a distance dᵢ between two working layers separated by a layer of rubber compound Ci and measured at the end of the axially narrowest working layer in contact with it being such that 0.5<dᵢ<2.5 mm, and, in a meridian plane, the thickness of at least one layer of rubber compound Ci being substantially constant over the axial width comprised between the axially inner end of the said at least one layer of rubber compound Ci and the end of the axially narrowest working layer in contact therewith.

For preference, according to the invention, in a meridian plane, the thickness of the said at least three working crown layers, measured in the equatorial plane, is less than 3.5 mm.

For preference also, according to the invention, the distance between the reinforcing elements, measured along the normal to the direction of the mean line of the wire, is less than 0.5 mm.

For preference also, according to the invention, the axial width of each of the said at least three working crown layers is greater than 80 and preferably less than 95% of the axial width of the tread.

The axial widths of the layers of reinforcing elements are measured on a cross section of a tire, the tire therefore being in a non-inflated state.

The axial width of the tread is measured between two shoulder ends when the tire is mounted on its service rim and inflated to its nominal pressure.

A shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

Within the meaning of the invention, the distance dᵢ is measured in a meridian plane from wire to wire, namely between the wire of a first working layer and the wire of a second working layer, in a direction substantially perpendicular to the surfaces of a layer of rubber compound Ci. In other words, this distance dᵢ encompasses the thickness of the layer of rubber compound Ci and the respective thicknesses of the rubber skim compounds, radially on the outside of the wires of the radially inner working layer and in contact with the layer Ci and radially on the inside of the wires of the radially outer working layer and in contact with the layer Ci.

Within the meaning of the invention, the thickness of a layer of rubber compound Ci is measured between the two surfaces of the said layer Ci along the orthogonal projection of a point of one surface onto the other surface.

Within the meaning of the invention, the statement that the thickness of a layer of rubber compound Ci is substantially constant means that it does not vary by more than 0.3 mm. These variations in thickness are due solely to creep phenomena during the building and curing of the tire. The layer Ci in semi-finished form, which means to say by way of elements ready to be used to create a tire, thus advantageously exhibits a constant thickness.

The various thickness measurements are made on a cross section of a tire, the tire therefore being in a non-inflated state.

The said at least two layers of rubber compound Ci can be used to decouple the two working crown layers respectively in contact therewith, in order to distribute the shear stresses over a greater thickness. These shear stresses appear in particular as a result of circumferential tensions during passage through the contact patch.

Within the meaning of the invention, coupled layers are layers the respective reinforcing elements of which are separated radially from one another solely by the presence of the skim layers with which the said layers are skimmed. In other words, layers which are coupled are layers which are in contact with one another.

The more conventional tire designs provide layers of rubber compound placed between the ends of two working crown layers, with greater thicknesses, notably, at the end of the narrowest working layer and with a non-uniform thickness profile when viewed along a meridian section of the tire in order to permit such a thickness and avoid excessive disturbance of the environment of the end of the narrowest working layer. The presence of this layer of rubber compound makes it possible in particular to limit the shear stresses between the ends of the working crown layers, the said working crown layers having no circumferential stiffness at their ends. The distance between the end of the axially narrowest working layer and the working layer separated from the axially narrowest working layer by the layer of rubber compound, measured in accordance with the definition of d above, is usually greater than 3.3 mm. This corresponds to a thickness of the layer of rubber compound of at least 2.5 mm, whereas, generally, its thickness tends, at each of its ends, towards a value of less than 0.5 mm.

For preference according to the invention, the crown reinforcement comprises four working crown layers of reinforcing elements and three layers of rubber compound C1, C2, C3 are arranged respectively between the ends of the said four working crown layers, the thickness of the said four working crown layers, measured in the equatorial plane, being less than 5 mm.

For preference also according to the invention, the distance dᵢ between two working layers separated by one of the three layers of rubber compound C1, C2, C3 and measured at the end of the axially narrowest working layer in contact therewith is such that 0.5<dᵢ<2.5 mm and, in a meridian plane, the thickness of each of the three layers of rubber compound C1, C2, C3 is substantially constant over the axial width comprised between its axially inner end and the end of the axially narrowest working layer in contact therewith.

The results obtained with tires according to the invention have effectively demonstrated that, for performance that is at least equivalent in terms of endurance and wear, the tires according to the invention have a lower mass and lower manufacturing costs.

The inventors have been able to demonstrate that this lightening of the tire is connected with a reduction in the thickness of the crown reinforcement as a result of the reduction in the diameter of the reinforcing elements of the working layers. This reduction in the diameter of the reinforcing elements is associated with thicknesses of polymer compound that are reduced by comparison with those of conventional tires and thus an overall thickness of the crown reinforcement that is less than that of conventional tires, despite there being four working crown layers.

The inventors have notably been able to demonstrate that it is possible to reduce the distances between the reinforcing elements within one and the same working crown layer by comparison with more conventional designs without adversely affecting the endurance properties of the tire. Specifically, it is commonplace to maintain a minimum distance between the reinforcing elements of one and the same working layer so as to limit the phenomena whereby cracks spread from one element to another.

The inventors believe that the presence of at least three working layers reduces the risks of cracks appearing at the ends of the working layers because of the distribution of the stresses between the various pairs of working layers subjected to cleaving effects. This reduction in the initiation of cracks thus leads to the possibility of reducing the distances between the reinforcing elements.

This reducing of the distances between the reinforcing elements of one and the same working layer contributes to reducing the volume of polymer compound and therefore works in favor of reducing the mass of the tire.

Moreover, the distance between the reinforcing elements, as defined according to the invention, combined with the number of working crown layers, makes it possible to maintain circumferential stiffness properties similar to those of a tire of more conventional design.

At the shoulders of the tire, the circumferential stiffness conferred by the crown reinforcement is even greater than that obtained with conventional tires. The inventors once again believe that the presence of at least three working crown layers, leading to a distribution of the stresses between the various pairs of working layers subjected to cleaving effects and therefore to a reduction in the stresses between each pair of working layers, makes it possible to limit the relative movements of two working layers forming an adjacent pair and thus provides efficient coupling as close as possible to the ends of the said working layers.

The inventors have been able to demonstrate that the crown reinforcement comprising at least three working crown layers makes it possible to maintain performance, notably in terms of endurance but also in terms of wear, that is satisfactory with at least one layer of rubber compound Ci of substantially constant thickness over the axial width comprised between the axially inner end of the said at least one layer of rubber compound Ci and the end of the axially narrowest working layer in contact therewith, and such that the distance dᵢ is comprised between 0.5 and 2.5 mm. It would indeed appear that the crown reinforcement comprising at least three working crown layers makes enough of a contribution to reacting at least some of the circumferential tension at the shoulders notably during passage through the contact patch that the shear stresses between the ends of the different working crown layers are reduced. The inventors also confirm that, in the case of four working layers, three layers C1, C2, C3, of substantially constant thicknesses and such that the distances d₁, d₂, d₃ are comprised between 0.5 and 2.5 mm, performance notably in terms of endurance but also in terms of wear is satisfactory.

Furthermore, the layers of rubber compound C1, C2, C3 are advantageously provided in the semi-finished state in the form of a layer of constant thickness which is simple to manufacture and in addition which can be stored easily. This is because the layers normally used as described above, which in cross section exhibit a form with variations in thickness, are, firstly, more difficult to produce and, secondly, more difficult to store. This is because the variations in thickness create storage problems, these semi-finished products generally being stored in a form wound onto a spool.

Because the manufacture and storage of the layers of rubber compound C1, C2, C3 according to the invention, in the form of semi-finished products, are thus simplified to such an extent, this results in lower costs for the manufacture of the tire.

The inventors have also demonstrated that the greater circumferential stiffness at the shoulders makes it possible to improve the properties of the tire in terms of wear. Specifically, the appearance of uneven wearing between the center and the edge of the tread that occurs under certain running conditions is reduced by comparison with what may be observed on more conventional designs. The reduction in the diameters of the reinforcing elements of the working layers also makes it possible to reduce the sensitivity of the tire to tread attack, as the crown design according to the invention is more flexible overall than is the case in more conventional tires.

Advantageously according to the invention, in order to obtain satisfactory circumferential stiffnesses, whatever the running conditions, the diameter of the individual metal wires of the four working crown layers is greater than or equal to 0.25 mm.

Advantageously according to the invention, the stiffness per unit width of each of the working crown layers is comprised between 35 and 70 daN/mm.

The stiffness per unit width of a layer of reinforcing elements is determined from measurements taken on the reinforcing elements and from the density of reinforcing elements in the layer, which density is itself defined as the number of reinforcing elements per unit width.

The density measurement is performed by visually counting the number of wires present on a non-deformed sample of fabric with a width of 10 cm. The number of wires counted directly gives the value for the density of the fabric in wires/dm.

According to one preferred embodiment of the invention, notably with a view to optimizing the weight savings of the tire, with a working crown layer of reinforcing elements comprising two skim layers between which the reinforcing elements are positioned, the thickness of skim measured in a radial direction on each side of a reinforcing element is less than 0.30 mm. In a tire, the thickness of skim is measured by halving the distance between the reinforcing elements of two layers of reinforcing elements in contact with one another.

For preference also according to the invention, the mean angle formed by the reinforcing elements of the said at least two working layers with the circumferential direction is less than 30°. Such angle values make it possible to further limit the relative movements of two working layers as a result of greater circumferential stiffness.

According to a first alternative form of embodiment of the invention in the case of four working crown layers, the two working crown layers radially between a radially innermost working crown layer and a radially outermost working crown layer are axially narrower than the two, radially innermost and radially outermost, working crown layers. The radially innermost working crown layer is therefore advantageously the layer that is axially the widest. This first alternative form of embodiment encourages lower dissipation of heat in the shoulder region of the tire.

According to a second alternative form of embodiment of the invention in the case of four working crown layers, the two, radially innermost and radially outermost, working crown layers are axially narrower than the two working crown layers radially between the radially innermost working crown layer and the radially outermost working crown layer. This second alternative form of embodiment is of particular relevance in limiting the damage caused by kerbing. Either: the working crown layer adjacent to the radially innermost layer is the axially widest layer; such a configuration makes it possible to keep the ends of the working layers away from the impact zone. Or: the working crown layer adjacent to the radially outermost layer is the axially widest layer; such a configuration then makes it possible to keep the ends subjected to the impact away from the carcass reinforcement which could be impacted.

According to other alternative forms of embodiment of the invention in the case of four working crown layers, a working crown layer radially on the inside or on the outside of the other working crown layers and a working crown layer radially between the radially inner and outer working crown layers are axially wider than the other two working crown layers.

According to one advantageous alternative form of embodiment of the invention, the tensile modulus of elasticity at 10% elongation of at least one layer of rubber compound Ci is less than 8 MPa and the maximum value of tan(δ), denoted tan(δ)ₘₐₓ, for the said at least one layer Ci is less than 0.100.

The loss factor, tan(δ), is a dynamic property of the layer of rubber compound. It is measured with a viscosity analyser known by the trade name Metravib VA4000, according to standard ASTM D5992-96. The response of a sample of vulcanized composition (cylindrical test specimen with a thickness of 2 mm and with a cross section of 78 mm²), subjected to a simple alternating sinusoidal shear stress, at a frequency of 10 Hz, at a temperature of 100° C., is recorded. A strain amplitude sweep is carried out from 0.1% to 50% (outward cycle) and then from 50% to 1% (return cycle). For the return cycle, the maximum observed value for tan(δ) is indicated, denoted tan(δ)ₘₐₓ.

The rolling resistance is the resistance appearing when the tire rolls. It is represented by the hysteresis losses related to the deformation of the tire during a revolution. The frequency values associated with the revolving of the tire correspond to tan(δ) values measured between 30 and 100° C. The value for tan(δ) at 100° C. thus corresponds to an indicator of the rolling resistance of the tire when running.

It is also possible to estimate the rolling resistance by measuring the energy losses by rebound of specimens at a set energy level at temperatures of 60° C., expressed in percentage terms.

Advantageously, according to the invention, the loss at 60° C., denoted P60, of the said at least one layer of rubber compound Ci is less than 20%.

According to this alternative form of the invention, the performance in terms of rolling resistance is improved and makes it possible to contribute to a reduced consumption of fuel by vehicles equipped with such tires.

By using these compounds whose moduli of elasticity are less than or equal to 8 MPa and in which the value of tan(δ)ₘₐₓ is less than 0.100, it is possible to improve the properties of the tire in terms of rolling resistance, while retaining satisfactory endurance properties.

According to a preferred embodiment according to this alternative form of embodiment of the invention, the said at least one layer of rubber compound Ci is an elastomeric compound based on natural rubber or on synthetic polyisoprene predominantly comprising cis-1,4 chains and optionally on at least one other diene elastomer, the natural rubber or the synthetic polyisoprene, in the case of a blend, being present at a predominant content with respect to the content of the other diene elastomer(s) used, and on a reinforcing filler consisting:
a) either of carbon black with a BET specific surface of greater than 60 m²/g,
   i. used at a content of between 20 and 40 phr when the oil absorption number (COAN) of the carbon black is greater than 85,
   ii. used at a content of between 20 and 60 phr when the oil absorption number (COAN) of the carbon black is less than 85,
b) or of carbon black with a BET specific surface of less than 60 m²/g, whatever its oil absorption number, employed at a content of between 20 and 80 phr and preferably between 30 and 50 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 30 and 260 m²/g, employed at a content of between 20 and 80 phr and preferably between 30 and 50 phr,
d) or of a blend of carbon black described in (a) and/or of carbon black described in (b) and/or a white filler described in (c), in which the overall content of filler is between 20 and 80 phr and preferably between 40 and 60 phr.

The BET specific surface measurement is performed in accordance with the BRUNAUER, EMMET and TELLER method described in “The Journal of the American Chemical Society”, Vol. 60, page 309, February 1938, corresponding to standard NFT 45007, November 1987.

The oil absorption number of the carbon black, COAN (Compressed Oil Absorption Number), is measured according to standard ASTM D3493.

If a clear filler or white filler is used, a coupling and/or coating agent, chosen from agents known to those skilled in the art, must be used. Mention may be made, as examples of preferred coupling agents, of alkoxysilane sulfides of the bis(3-trialkoxysilylpropyl) polysulfide type and among these in particular of bis(3-triethoxysilylpropyl) tetrasulfide, sold by Degussa under the name Si69 for the pure liquid product and the name X50S for the solid product (blended 50/50 w/w with N330 black). Mention may be made, as examples of coating agents, of a fatty alcohol, an alkylalkoxysilane, such as a hexadecyltrimethoxysilane or hexadecyltriethoxysilane respectively sold by Degussa under the names Si116 and Si216, diphenylguanidine, a polyethylene glycol or a silicone oil, optionally modified by means of OH or alkoxy functional groups. The coating and/or coupling agent is used in a proportion of ≥1/100 and ≤20/100 by weight to the filler, and preferably in the range from 2/100 to 15/100 if the clear filler forms the whole of the reinforcing filler and in the range from 1/100 to 20/100 if the reinforcing filler is formed by a blend of carbon black and clear filler.

Mention may be made, as other examples of reinforcing fillers having the morphology and the SiOH and/or AlOH surface functional groups of the materials of silica and/or alumina type described above and which can be used according to the invention as partial or complete replacement for these, of carbon blacks modified either during the synthesis, by addition, to the feed oil of the furnace, of a silicon and/or aluminium compound, or after the synthesis, by adding an acid to an aqueous suspension of carbon black in a sodium silicate and/or aluminate solution, so as to at least partially cover the surface of the carbon black with SiOH and/or AlOH functional groups. Mention may be made, as nonlimiting examples of carbon-based fillers of this type with SiOH and/or AlOH functional groups at the surface, of the fillers of CSDP type described in Conference No. 24 of the ACS Meeting, Rubber Division, Anaheim, Calif., 6-9 May 1997, and also those of Patent Application EP-A-0 799 854.

If a clear filler is used as the sole reinforcing filler, the properties of hysteresis and cohesion are obtained by using a precipitated or pyrogenic silica or a precipitated alumina or an aluminosilicate with a BET specific surface in the range from 30 to 260 m²/g. Mention may be made, as nonlimiting examples of filler of this type, of the silicas KS404 from Akzo, Ultrasil VN2 or VN3 and BV3370GR from Degussa, Zeopol 8745 from Huber, Zeosil 175MP or Zeosil 1165MP from Rhodia, HI-SIL 2000 from PPG, and the like.

Among the diene elastomers that may be used in a blend with natural rubber or a synthetic polyisoprene with a majority of cis-1,4 chains, mention may be made of a polybutadiene (BR), preferably with a majority of cis-1,4 chains, a stirene-butadiene copolymer (SBR) solution or emulsion, a butadiene-isoprene copolymer (BIR), and a stirene-butadiene-isoprene terpolymer (SBIR). These elastomers can be elastomers modified during polymerization or after polymerization by means of branching agents, such as a divinylbenzene, or star-branching agents, such as carbonates, halotins or halosilicons, or alternatively by means of functionalization agents resulting in a grafting, to the chain or at the chain end, of oxygen-comprising carbonyl or carboxyl functional groups or else of an amine functional group, such as, for example, by the action of dimethylaminobenzophenone or diethylaminobenzophenone. In the case of blends of natural rubber or synthetic polyisoprene predominantly comprising cis-1,4 chains with one or more of the diene elastomers mentioned above, the natural rubber or the synthetic polyisoprene is preferably used at a predominant content and more preferably at a content of greater than 70 phr.

According to this preferred embodiment of the invention, a lower modulus of elasticity is generally accompanied by a lower viscous modulus G″, this change proving to be favorable to a reduction in the rolling resistance of the tire.

The more conventional tire designs provide layers of rubber compound positioned between the ends of the working crown layers with tensile moduli of elasticity at 10% elongation of greater than 8.5 MPa, in particular in order to make it possible to limit the shear stresses between the ends of the working crown layers, the said working crown layers having no circumferential stiffness at their ends. Such moduli, which generally are even greater than 9 MPa, make it possible to prevent cracking from starting and propagating in the rubber compounds at the ends of the said working crown layers and more particularly at the end of the narrowest working layer.

The inventors have been able to demonstrate that the presence of at least three working layers makes it possible to retain satisfactory performance, in particular in terms of endurance but also in terms of wear, with a tensile modulus of elasticity at 10% elongation of at least one layer Ci of less than 8 MPa.

The inventors have also been able to demonstrate that the cohesion of the said at least one layer Ci, when it exhibits a tensile modulus of elasticity at 10% elongation of less than 8 MPa, remains satisfactory.

Within the meaning of the invention, a cohesive rubber compound is a rubber compound which is, notably, resistant to cracking. The cohesion of a compound is thus evaluated by a fatigue cracking test carried out on a “PS” (pure shear) test specimen. It consists in determining, once the test specimen has been notched, the crack propagation rate “Vp” (nm/cycle) as a function of the energy release rate “E” (J/m²). The experimental domain covered by the measurement is within the range −20° C. and +150° C. in temperature, with an air or nitrogen atmosphere. The stressing of the test specimen is an imposed dynamic movement with an amplitude of between 0.1 mm and 10 mm in the form of an impulsive stress loading (“haversine” tangent signal) with a rest time equal to the duration of the impulse; the frequency of the signal is of the order of 10 Hz on average.

The measurement comprises 3 parts:
An accommodation of the “PS” test specimen, of 1000 cycles at 27% deformation.
Energy characterization in order to determine the “E”=f (deformation) law. The energy release rate “E” is equal to W0*h0, with W0=energy supplied to the material per cycle and per unit volume and h0=initial height of the test specimen. Exploitation of the “force/displacement” acquisitions thus gives the relationship between “E” and the amplitude of the stress loading.
The measurement of cracking, after the test specimen “PS” has been notched. The data collected results in the determination of the crack propagation rate “Vp” as a function of the imposed stress loading level “E”.

The inventors have notably demonstrated that the presence of at least three working layers helps to reduce the changes in cohesion of the said at least one layer Ci. Specifically, the more conventional tire designs notably comprising layers of rubber compound placed between the ends of the working crown layers with tensile moduli of elasticity at 10% elongation greater than 8.5 MPa lead to a change in the cohesion of the said layers of rubber compound placed between the ends of the working crown layers, this change having a tendency to be for the worse. The inventors observe that the presence of at least three working layers which limit the movements between the ends of the working crown layers, combined with a maximum value for tan(δ) for at least one layer Ci of less than 0.100, leads to a small change in the cohesion of the said at least one layer Ci as a result of the limiting the increases in temperature. The inventors thus consider that the cohesion of the said at least one layer Ci, which is lower than that found in the more conventional tire designs, is satisfactory in the tire design according to the invention.

The inventors also find that three layers C1, C2, C3 of rubber compound, associated with four working layers having a tensile modulus of elasticity at 10% elongation of less than 8 MPa and a maximum value for tan(δ), denoted tan(δ)ₘₐₓ, of less than 0.100, offer improved performance in terms of rolling resistance while maintaining satisfactory properties of endurance and wear.

According to an alternative form of embodiment of the invention, the tensile modulus of elasticity at 10% elongation of at least one skim layer of at least one working crown layer is less than 8.5 MPa and the maximum value for tan(δ), denoted tan(δ)ₘₐₓ, of the said at least one skim layer of at least one working crown layer is less than 0.100.

Usually, the tensile moduli of elasticity at 10% elongation of the skim layers of the working crown layers are greater than 10 MPa. Such moduli of elasticity are required in order to make it possible to limit the compressing of the reinforcing elements of the working crown layers, in particular when the vehicle is following a tortuous route, during maneuvers in car parks or else when crossing roundabouts. This is because the shearing actions along the axial direction which act on the tread in the region of the patch in contact with the ground result in the compressing of the reinforcing elements of a working crown layer.

The inventors have also been able to demonstrate that the presence of at least three working layers according to the invention allows lower moduli of elasticity without harming the properties of endurance of the tire as a result of the compressing of the reinforcing elements of the working crown layers as described above.

As in the case of the layers of rubber compound Ci, the use of at least one skim layer of at least one working crown layer, the modulus of elasticity of which is less than or equal to 8.5 MPa and the tan(δ)ₘₐₓ value of which is less than 0.100, will make it possible to improve the properties of the tire as regards rolling resistance while retaining satisfactory endurance properties.

In a preferred embodiment of the invention, the said at least one skim layer of at least one working crown layer is an elastomeric compound based on natural rubber or on synthetic polyisoprene with a majority of cis-1,4 chains, and possibly on at least one other diene elastomer, the natural rubber or the synthetic polyisoprene in the case of a blend being present in a majority proportion relative to the proportion of the other diene elastomer or elastomers used, and on a reinforcing filler composed:
a) either of carbon black with a BET specific surface of greater than 60 m²/g,
   i. used at a content of between 20 and 40 phr when the oil absorption number (COAN) of the carbon black is greater than 85,
   ii. used at a content of between 20 and 60 phr when the oil absorption number (COAN) of the carbon black is less than 85,
b) or of carbon black with a BET specific surface of less than 60 m²/g, whatever its oil absorption number, employed at a content of between 20 and 80 phr and preferably between 30 and 50 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 30 and 260 m²/g, employed at a content of between 20 and 80 phr and preferably between 30 and 50 phr,
d) or of a blend of carbon black described in (a) and/or of carbon black described in (b) and/or a white filler described in (c), in which the overall content of filler is between 20 and 80 phr and preferably between 40 and 60 phr.

If a clear filler or white filler is used, a coupling and/or coating agent, chosen from agents known to those skilled in the art, must be used. Mention may be made, as examples of preferred coupling agents, of alkoxysilane sulfides of the bis(3-trialkoxysilylpropyl) polysulfide type and among these in particular of bis(3-triethoxysilylpropyl) tetrasulfide, sold by Degussa under the name Si69 for the pure liquid product and the name X50S for the solid product (50/50 by weight blend with N330 black). Mention may be made, as examples of coating agents, of a fatty alcohol, an alkylalkoxysilane, such as a hexadecyltrimethoxysilane or hexadecyltriethoxysilane respectively sold by Degussa under the names Si116 and Si216, diphenylguanidine, a polyethylene glycol or a silicone oil, optionally modified by means of OH or alkoxy functional groups. The coating and/or coupling agent is used in a proportion of ≥1/100 and ≤20/100 by weight to the filler, and preferably in the range from 2/100 to 15/100 if the clear filler forms the whole of the reinforcing filler and in the range from 1/100 to 20/100 if the reinforcing filler is formed by a blend of carbon black and clear filler.

Mention may be made, as other examples of reinforcing fillers having the morphology and the SiOH and/or AlOH surface functional groups of the materials of silica and/or alumina type described above and which can be used according to the invention as partial or complete replacement for these, of carbon blacks modified either during the synthesis, by addition, to the feed oil of the furnace, of a silicon and/or aluminium compound, or after the synthesis, by adding an acid to an aqueous suspension of carbon black in a sodium silicate and/or aluminate solution, so as to at least partially cover the surface of the carbon black with SiOH and/or AlOH functional groups. Mention may be made, as nonlimiting examples of carbon-based fillers of this type with SiOH and/or AlOH functional groups at the surface, of the fillers of CSDP type described in Conference No. 24 of the ACS Meeting, Rubber Division, Anaheim, Calif., 6-9 May 1997, and also those of Patent Application EP-A-0 799 854.

If a clear filler is used as the sole reinforcing filler, the properties of hysteresis and cohesion are obtained by using a precipitated or pyrogenic silica or a precipitated alumina or an aluminosilicate with a BET specific surface in the range from 30 to 260 m²/g. Mention may be made, as nonlimiting examples of filler of this type, of the silicas KS404 from Akzo, Ultrasil VN2 or VN3 and BV3370GR from Degussa, Zeopol 8745 from Huber, Zeosil 175MP or Zeosil 1165MP from Rhodia, HI-SIL 2000 from PPG, and the like.

Among the diene elastomers that may be used in a blend with natural rubber or a synthetic polyisoprene with a majority of cis-1,4 chains, mention may be made of a polybutadiene (BR), preferably with a majority of cis-1,4 chains, a stirene-butadiene copolymer (SBR) solution or emulsion, a butadiene-isoprene copolymer (BIR), and a stirene-butadiene-isoprene terpolymer (SBIR). These elastomers can be elastomers modified during polymerization or after polymerization by means of branching agents, such as a divinylbenzene, or star-branching agents, such as carbonates, halotins or halosilicons, or alternatively by means of functionalization agents resulting in a grafting, to the chain or at the chain end, of oxygen-comprising carbonyl or carboxyl functional groups or else of an amine functional group, such as, for example, by the action of dimethylaminobenzophenone or diethylaminobenzophenone. In the case of blends of natural rubber or synthetic polyisoprene predominantly comprising cis-1,4 chains with one or more of the diene elastomers mentioned above, the natural rubber or the synthetic polyisoprene is preferably used at a predominant content and more preferably at a content of greater than 70 phr.

Also advantageously according to the invention, the difference between the tensile modulus of elasticity at 10% elongation of a layer Ci and the tensile modulus of elasticity at 10% elongation of the said at least one skim layer of at least one working crown layer in contact with the said at least one layer Ci is less than 2 MPa.

According to a first embodiment, the modulus of elasticity of the skim of a working crown layer the end of which is in contact with a layer Ci of rubber compound is greater than that of the said layer Ci of rubber compound in order for the stack of the said layers to exhibit a modulus of elasticity gradient favourable to the combating of the initiation of cracking at the end of the narrowest working crown layer.

According to a second embodiment, the moduli of elasticity of the skim of the working crown layers and of that of the said layer Ci of rubber compound are identical and advantageously again the rubber compounds are the same in order to simplify the industrial conditions for the manufacture of the tire.

The tire according to the invention as just described in its alternative forms of embodiment thus exhibits an improved rolling resistance in comparison with conventional tires while retaining comparable performance in terms of endurance and wear.

In addition, the lower moduli of elasticity of the various rubber compounds make it possible to render the crown of the tire flexible and to thus limit the risks of attacks on the crown and of corrosion of the reinforcing elements of the crown reinforcement layers when, for example, stones are retained in the bottoms of the tread pattern.

According to one embodiment of the invention, the crown reinforcement is supplemented by a layer of circumferential reinforcing elements.

The presence of a layer of circumferential reinforcing elements goes against the idea of lightening the tire and therefore offsets the performance compromise between lightening and the endurance properties of the tire; the layer of circumferential reinforcing elements may make it possible to improve the endurance of the tire for particularly harsh use.

For preference, at least one layer of circumferential reinforcing elements is radially positioned between two working crown layers.

According to one advantageous embodiment of the invention, the reinforcing elements of at least one layer of circumferential reinforcing elements are metallic reinforcing elements having a secant modulus at 0.7% elongation in the range from 10 to 120 GPa and a maximum tangent modulus of less than 150 GPa.

According to one preferred embodiment, the secant modulus of the reinforcing elements at 0.7% elongation is less than 100 GPa and greater than 20 GPa, preferably in the range from 30 to 90 GPa, and more preferably less than 80 GPa.

For preference also, the maximum tangent modulus of the reinforcing elements is less than 130 GPa and more preferably less than 120 GPa.

The moduli expressed above are measured on a curve of tensile stress as a function of elongation, the tensile stress corresponding to the tension measured, with a preload of 5 N, with respect to the cross section of metal of the reinforcing element.

According to one preferred embodiment, the reinforcing elements of at least one layer of circumferential reinforcing elements are metal reinforcing elements that have a curve of tensile stress as a function of relative elongation that exhibits shallow gradients for small elongations and a gradient that is substantially constant and steep for greater elongations. Such reinforcing elements of the additional ply are normally known as “bimodulus” elements.

In a preferred embodiment of the invention, the substantially constant steep gradient appears from the point of a relative elongation in the range from 0.4% to 0.7%.

The various characteristics of the reinforcing elements mentioned above are measured on reinforcing elements taken from tires.

Reinforcing elements that are more particularly suitable for creating at least one layer of circumferential reinforcing elements according to the invention are for example assemblies of construction 3×(0.26+6×0.23) 5.0/7.5 SS. Such a cord has a secant modulus at 0.7% equal to 45 GPa and a maximum tangent modulus equal to 100 GPa, these being measured on a curve of tensile stress as a function of elongation, the tensile stress corresponding to the tension measured, with a preload of 5 N, with respect to the cross section of metal of the reinforcing element, of 0.98 mm² in the case of the example in question.

According to a second embodiment of the invention, the circumferential reinforcing elements may be formed of metal elements cut so as to form portions having a length much less than the circumference of the shortest layer, but preferably greater than 0.1 times the said circumference, the cuts between portions being axially offset with respect to one another. Preferably again, the tensile modulus of elasticity per unit width of the additional layer is less than the tensile modulus of elasticity, measured under the same conditions, of the most extensible working crown layer. Such an embodiment makes it possible, in a simple way, to confer on the layer of circumferential reinforcing elements a modulus which can be easily adjusted (by the choice of the intervals between sections of one and the same row) but which in all cases is lower than the modulus of the layer consisting of the same metal elements but with the latter being continuous, the modulus of the additional layer being measured on a vulcanized layer of cut elements which has been removed from the tire.

According to a third embodiment of the invention, the circumferential reinforcing elements are wavy metal elements, the ratio a of the wave amplitude to the wavelength being at most equal to 0.09. For preference, the tensile modulus of elasticity per unit width of the additional layer is less than the tensile modulus of elasticity, measured under the same conditions, of the most extensible working crown layer.

A preferred embodiment of the invention also provides for the crown reinforcement to be supplemented radially on the outside by at least one additional layer, referred to as a protective layer, of reinforcing elements that are oriented with respect to the circumferential direction at an angle of between 10° and 45° and in the same direction as the angle formed by the elements of the working layer which is radially adjacent thereto.

According to a first embodiment of the invention, corresponding to conventional tire designs, the reinforcing elements of the protective layer are elastic cords.

According to a second embodiment of the invention, the reinforcing elements of the protective layer are individual metal wires of diameter less than 0.50 mm, the distance between the reinforcing elements, measured along the normal to the direction of the mean line of the wire, being strictly less than 1.5 mm.

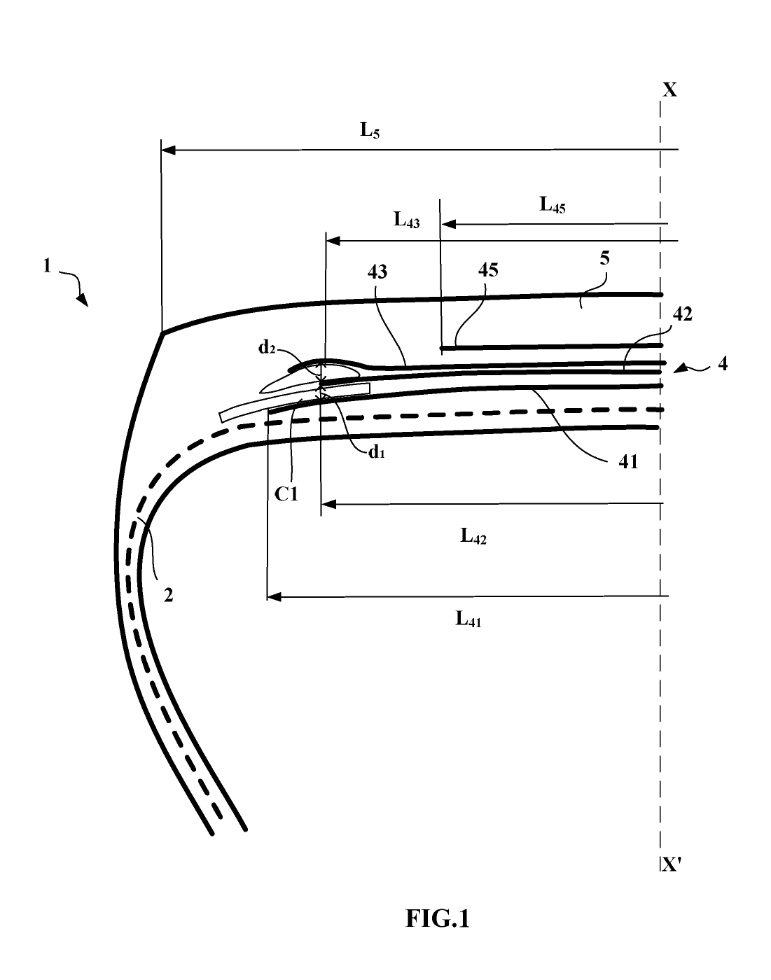

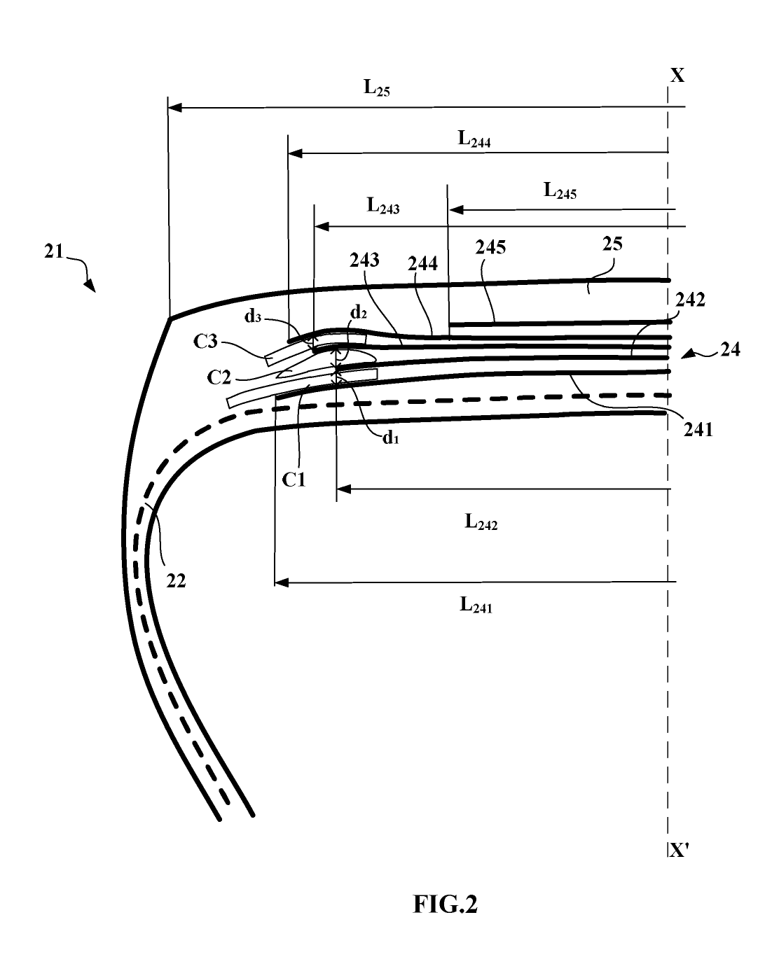

Other advantageous details and features of the invention will become evident hereinbelow from the description of the exemplary embodiments of the invention, with reference to FIGS. 1 and 2, which represent:

FIG. 1: a schematic meridian view of a tire according to a first embodiment of the invention,

FIG. 2: a schematic meridian view of a tire according to a second embodiment of the invention,

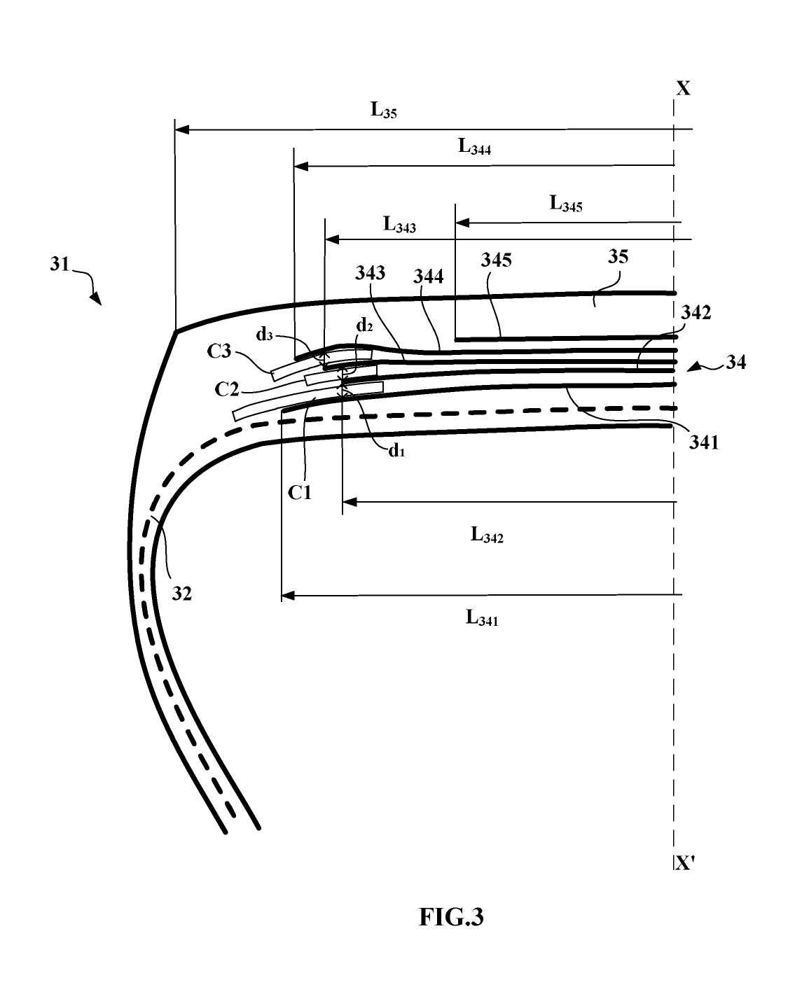

FIG. 3: a schematic meridian view of a tire according to a third embodiment of the invention,

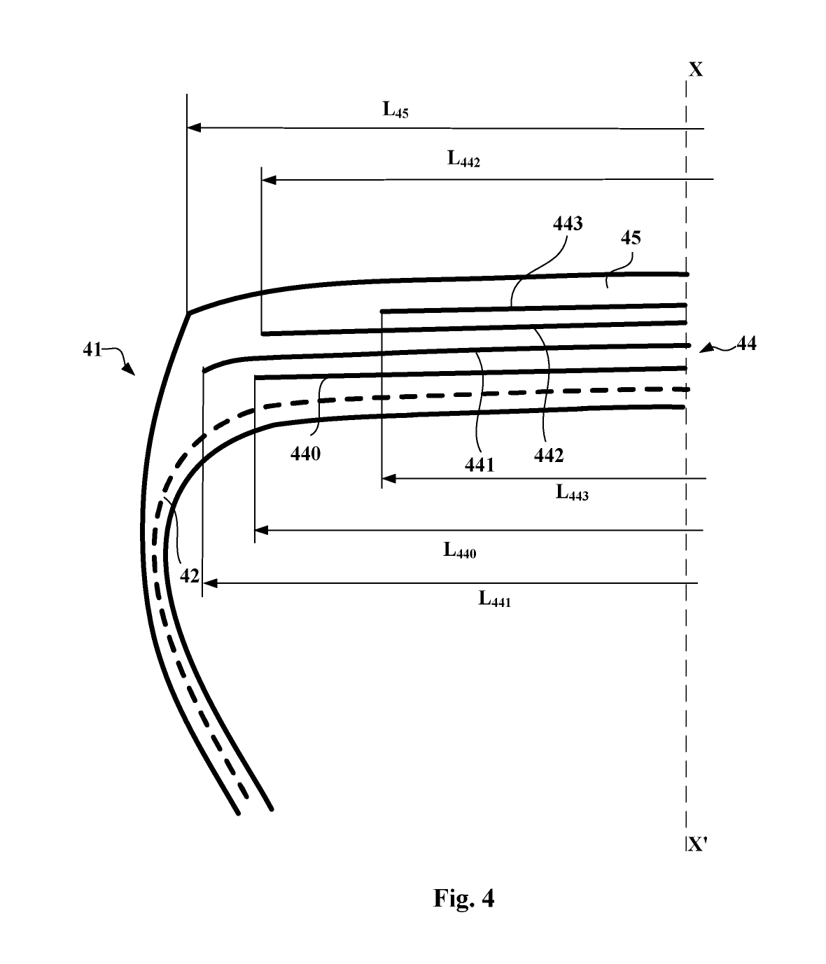

FIG. 4: a schematic meridian view of a tire according to the prior art.

In order to make them easier to understand, the figures have not been drawn to scale. The figures depict only a half-view of a tire, which extends symmetrically with respect to the axis XX′, which represents the circumferential median plane, or equatorial plane, of a tire.

In the figures, the tires 1-41, of size 385/55 R 22.5, have an aspect ratio H/S equal to 0.55, H being the height of the tire 1-41 on its mounting rim and S its maximum axial width. The said tires 1-41 comprise a radial carcass reinforcement 2-42 anchored in two beads, not depicted in the figures. The carcass reinforcement 2-42 is formed of a single layer of metal cords. They further comprise a tread 5-45.

In FIG. 1, the carcass reinforcement 2 is hooped according to the invention by a crown reinforcement 4 formed radially, from the inside to the outside:
of a first working layer 41 formed of metal wires oriented at an angle equal to −18°,
of a second working layer 42 formed of metal wires oriented at an angle equal to 18°,
of a third working layer 43 formed of metal wires oriented at an angle equal to −18°,
of a protective layer 45 formed of 6.35 elastic metal cords parallel to the metal wires of the working layer 43.

The metal wires that make up the reinforcing elements of the three working layers are wires of the UHT type having a diameter of 0.35 mm. Wires of SHT type or of higher grades may also be used. They are distributed within each of the working layers with a distance between the reinforcing elements, measured along the normal to the direction of the mean line of the wire, equal to 0.35 mm.

The axial width L₄₁ of the first working layer 41 is equal to 300 mm.

The axial width L₄₂ of the second working layer 42 is equal to 320 mm.

The axial width L₄₃ of the third working layer 43 is equal to 300 mm.

The axial width L₄₅ of the protective layer 45 is equal to 220 mm.

The axial width of the tread L₅ is equal to 312 mm.

The thickness of the three working crown layers, measured in the equatorial plane, is equal to 2.5 mm and therefore less than 5 mm.

According to the invention, two layers of rubber compound C1, C2 respectively provide decoupling of the ends of the working crown layers 41, 42 and 43.

The zone of engagement of the layer C1 between the two working crown layers 41 and 42 is defined by its thickness and more specifically by the radial distance d₁ between the end of the layer 42 and the layer 41. The radial distance d1 is equal to 2 mm, which corresponds to a thickness of the layer C1 equal to 1.5 mm. In accordance with the invention, the thickness of the layer C1 is substantially identical in a meridian view over the axial width between the axially inner end of the layer C1 and the end of the axially narrowest working layer 42.

Regarding the layer C2 between the two working crown layers 42 and 43, this is defined on the one hand by its thickness and more specifically the radial distance d₂ between the end of the layer 42 and the layer 43 and on the other hand by its shape which is irregular in a meridian view, this shape being thickest at the end of the layer 42, its thickness decreasing down to values of the order of 0.5 mm at its ends. The radial distance d₂ is equal to 3.5 mm, which corresponds to a thickness of the layer C2 equal to 2.7 mm.

In FIG. 2, the carcass reinforcement 22 is hooped according to the invention by a crown reinforcement 24 formed radially, from the inside to the outside:
of a first working layer 241 formed of metal wires oriented at an angle equal to 18°,
of a second working layer 242 formed of metal wires oriented at an angle equal to −18°,
of a third working layer 243 formed of metal wires oriented at an angle equal to 18°,
of a fourth working layer 244 formed of metal wires oriented at an angle equal to −18°,
of a protective layer 245 formed of 6.35 elastic metal cords parallel to the metal wires of the working layer 244.

The metal wires that make up the reinforcing elements of the four working layers are wires of the UHT type having a diameter of 0.35 mm. Wires of SHT type or of higher grades may also be used. They are distributed within each of the working layers with a distance between the reinforcing elements, measured along the normal to the direction of the mean line of the wire, equal to 0.35 mm.

The axial width L₂₄₁ of the first working layer 241 is equal to 300 mm.

The axial width L₂₄₂ of the second working layer 242 is equal to 320 mm.

The axial width L₂₄₃ of the third working layer 243 is equal to 300 mm.

The axial width L₂₄₄ of the fourth working layer 244 is equal to 280 mm.

The axial width L₂₄₅ of the protective layer 245 is equal to 220 mm.

The axial width of the tread L₂₅ is equal to 312 mm.

The thickness of the four working crown layers, measured in the equatorial plane, is equal to 3.3 mm and therefore less than 5 mm.

According to the invention, three layers of rubber compound C1, C2, C3 respectively provide decoupling of the ends of the working crown layers 241, 242, 243 and 244.

The zone of engagement of the layers C1 and C3 respectively between the two working crown layers 241, 242 and 243, 244 is defined by their thicknesses and more specifically the respective radial distances d₁ and d₃ between the end of the layer 242 and the layer 241, and between the end of the layer 243 and the layer 244. The radial distances d1 and d₃ are equal to 2 mm, which corresponds to a thickness of the layers C1 and C3 equal to 1.5 mm. In accordance with the invention, the thickness of the layer C1 is substantially identical in a meridian view over the axial width between the axially inner end of the layer C1 and the end of the axially narrowest working layer 42 in contact therewith. Likewise, the thickness of the layer C3 is substantially identical in a meridian view over the axial width between the axially inner end of the layer C3 and the end of the axially narrowest working layer 43 in contact therewith.

Regarding the layer C2 between the two working crown layers 242 and 243, this is defined on the one hand by its thickness and more specifically the radial distance d₂ between the end of the layer 242 and the layer 243 and on the other hand by its shape which is irregular in a meridian view, this shape being thickest at the end of the layer 42, its thickness decreasing down to values of the order of 0.5 mm at its ends. The radial distance d₂ is equal to 3.5 mm, which corresponds to a thickness of the layer C2 equal to 2.7 mm.

In FIG. 3, the carcass reinforcement 32 is hooped according to the invention by a crown reinforcement 34 formed radially, from the inside to the outside:
of a first working layer 341 formed of metal wires oriented at an angle equal to 18°,
of a second working layer 342 formed of metal wires oriented at an angle equal to −18°,
of a third working layer 343 formed of metal wires oriented at an angle equal to 18°,
of a fourth working layer 344 formed of metal wires oriented at an angle equal to −18°,
of a protective layer 345 formed of 6.35 elastic metal cords parallel to the metal wires of the working layer 344.

The metal wires that make up the reinforcing elements of the four working layers are wires of the UHT type having a diameter of 0.35 mm. Wires of SHT type or of higher grades may also be used. They are distributed within each of the working layers with a distance between the reinforcing elements, measured along the normal to the direction of the mean line of the wire, equal to 0.35 mm.

The axial width L₃₄₁ of the first working layer 341 is equal to 300 mm.

The axial width L₃₄₂ of the second working layer 342 is equal to 320 mm.

The axial width L₃₄₃ of the third working layer 343 is equal to 300 mm.

The axial width L₃₄₄ of the fourth working layer 344 is equal to 280 mm.

The axial width L₂₄₅ of the protective layer 245 is equal to 220 mm.

The axial width of the tread L₂₅ is equal to 312 mm.

The thickness of the four working crown layers, measured in the equatorial plane, is equal to 3.3 mm and therefore less than 5 mm.

According to the invention, and as in the case with FIG. 2, three layers of rubber compound C1, C2, C3 respectively provide decoupling of the ends of the working crown layers 341, 342, 343 and 344.

In the case of FIG. 3, the three layers C1, C2, C3 are substantially identical.

The zone of engagement of the layers C1, C2 and C3 respectively between the two working crown layers 341 and 342, 342 and 343, 343 and 344 is defined by their thicknesses and more specifically the respective radial distances d₁, d₂ and d₃ between the end of the layer 342 and the layer 341, between the end of the layer 342 and the layer 343, and between the end of the layer 343 and the layer 344. The radial distances d₁, d₂ and d₃ are equal to 2 mm, which corresponds to a thickness of the layers C1, C2 and C3 equal to 1.5 mm. In accordance with the invention, the thickness of the layer C1 is substantially identical in a meridian view over the axial width between the axially inner end of the layer C1 and the end of the axially narrowest working layer 342 in contact therewith. Likewise, the thickness of the layer C2 is substantially identical in a meridian view over the axial width between the axially inner end of the layer C3 and the end of the axially narrowest working layer 342 in contact therewith. Likewise again, the thickness of the layer C3 is substantially identical in a meridian view over the axial width between the axially inner end of the layer C3 and the end of the axially narrowest working layer 343 in contact therewith.

In FIG. 4, the carcass reinforcement 42 is hooped by a crown reinforcement 44 formed radially, from the inside to the outside:
of a first triangulation layer 440 formed of non-wrapped 9.35 metal cords oriented at an angle equal to 50°,
of a first working layer 441 formed of non-wrapped 9.35 metal cords, which are continuous across the entire width of the ply, and oriented at an angle equal to 18°,
of a second working layer 442 formed of non-wrapped 9.35 metal cords which are continuous over the entire width of the ply, which are oriented at an angle equal to 18° and which are crossed with the metal cords of the layer 441,
of a protective layer 443 formed of elastic 6.35 metal cords.

The inextensible 9.35 metal cords of the working layers 441 and 442 are distributed within each of the working layers with a distance between the reinforcing elements, measured along the normal to the direction of the mean line of the wire, equal to 1 mm.

The axial width L₄₄₀ of the triangulation layer 440 is equal to 302 mm.

The axial width L₄₄₁ of the first working layer 441 is equal to 318 mm.

The axial width L₄₄₂ of the second working layer 442 is equal to 296 mm.

The axial width L₄₄₃ of the protective layer 443 is equal to 220 mm.

The axial width of the tread L₄₅ is equal to 312 mm.

The thickness of the three crown layers 440, 441, 442, measured in the equatorial plane, is equal to 6.5 mm.

Over the remaining width that the two working layers have in common, the two working layers 441, 442 are separated by the layer of rubber compound C. The layer C is defined on the one hand by its thickness and more specifically the radial distance d between the end of the layer 442 and the layer 441 and on the other hand by its shape which is irregular in a meridian view, this shape being thickest at the end of the layer 442, its thickness decreasing down to values of the order of 0.5 mm at its ends. The radial distance d is equal to 3.5 mm, which corresponds to a thickness of the layer C equal to 2.7 mm.

The preparation of tires according to the invention has demonstrated a simplifying of the manufacture, conditioning and storage of the layers Ci of rubber compound as semi-finished product before preparing a tire. The preparation itself of the tire is also simplified, the positioning and the accuracy of positioning of the said layers Ci being simpler as a result of their homogeneous form concerning their cross section.

The combined mass of the four working layers 341, 342, 343 and 344 of the tire according to the invention, produced as depicted in FIG. 3, including the mass of the metal wires and of the skim compounds, thus amounts to 6.3 kg. The mass of the tire according to the invention, produced as depicted in FIG. 2, is equal to 61 kg.

The combined mass of the crown layers 440, 441, 442 of the tire, produced as depicted in FIG. 3, including the mass of the metal cords and of the skim compounds, amounts to 12.6 kg. The mass of the tire, produced as depicted in FIG. 3, is equal to 67 kg.

Tests were conducted on tires produced in accordance with FIG. 3, the tire produced in accordance with FIG. 4 being the reference tire.

First endurance tests were conducted on a test machine, each tire being made to roll in a straight line at a speed equal to the maximum speed rating (or speed index) specified for the said tire under an initial load of 4000 kg which was progressively increased to reduce the duration of the test.

Other endurance tests were conducted on a test machine, a transverse force and a dynamic overload being applied to the tires in a cyclic manner. The tests were carried out for the tires according to the invention with conditions identical to those applied to the reference tires.

The tests thus carried out showed that the distances covered during each of these tests are substantially identical for the tires according to the invention and the reference tires. It is thus apparent that the tires according to the invention exhibit performance in terms of endurance which is substantially the equivalent of that of the reference tires.

Other tests were carried out to evaluate the wear performance of the tires under actual conditions on vehicles. The running conditions, in particular the circuit followed, are determined so as to be representative of a particular type of use, in this instance use of the motorway type that is more disadvantageous as regards uneven wear. At the end of the running, the wear on the tires according to the invention was found to be more even, indicating potential for increased life.

Measurements of rolling resistance were also made.

These tests are carried out with tires according to the invention while varying the characteristics of the compounds of the layers C1, C2, C3, in particular their tensile moduli of elasticity at 10% elongation and the tan(δ)ₘₐₓ values, in accordance with the invention.

Other tests are also carried out with tires according to the invention while also varying the characteristics of the skim layer compounds of the working layers, in particular their tensile moduli of elasticity at 10% elongation and the tan(δ)ₘₐₓ values, in accordance with the invention.

The various compounds used are listed below, the tensile modulus of elasticity at 10% elongation and the tan(δ)ₘₐₓ and P60 values being expressed for each.

| | Compound | Compound | | | | | |
|---|---|---|---|---|---|---|---|
| | R1 | R2 | Compound 1 | Compound 2 | Compound 3 | Compound 4 | Compound 5 |
| NR | 100 | 100 | 100 | 100 | 100 | 100 | 100 |
| Black N347 | 52 | 50 | | 33 | | | |
| Black N683 | | | | | | 44 | 30 |
| Black N326 | | | 47 | | | | |
| Silica 165G | | | | | 46 | | |
| Antioxidant (6PPD) | 1 | 1.8 | 1.5 | 1 | 2 | 1 | 1 |
| Stearic acid | 0.65 | 0.6 | 0.9 | 0.65 | 1 | 0.65 | 0.65 |
| Zinc oxide | 9.3 | 9.3 | 7.5 | 9.3 | 8 | 9.3 | 9.3 |
| Cobalt salt (CoAcac) | 1.12 | | 1.12 | 1.12 | 1.1 | 1.12 | 1.12 |
| Cobalt salt | | 4.5 | | | | | |
| (CoAbietate) | | | | | | | |
| Silane-on-black | | | | | 8.3 | | |
| Sulfur | 6.1 | 5.6 | 4.5 | 6.1 | 4.8 | 6.1 | 6.1 |
| Accelerator DCBS | 0.93 | 0.8 | 0.8 | 0.93 | | 0.93 | 0.93 |
| Accelerator TBBS | | | | | 1.01 | | |
| Coaccelerator DPG | | | | | 1.1 | | |
| Retarder CTP PVI | 0.25 | | 0.15 | 0.25 | 0.2 | 0.25 | 0.25 |
| MA₁₀ (MPa) | 10.4 | 8.5 | 5.99 | 5.56 | 7.25 | 6.16 | 4.4 |
| tan (δ)ₘₐₓ | 0.130 | 0.141 | 0.099 | 0.074 | 0.063 | 0.056 | 0.030 |
| P60 (%) | 22.9 | 24.5 | 18.7 | 14.9 | 13.3 | 12.2 | 8.5 |

The values of the constituents are expressed in phr (parts by weight per hundred parts of elastomers).

As regards the reference tire, denoted T1, the layer C is made of the compound R2 and the skim layers of the working layers 441, 443 are made of the compound R1.

Different tires according to the invention were tested.

A first series of tires S1 in accordance with the invention (FIG. 3) was prepared with layers C1, C2, C3 made of the compound R2, the skim layers of the working layers being made of the compound R1.

A second series of tires S2 in accordance with the invention (FIG. 3) was prepared with layers C1, C2, C3 made of the compounds 1 to 5, the skim layers of the working layers being made of the compound R1.

A third series of tires S3 in accordance with the invention (FIG. 3) was prepared with layers C1, C2, C3 made of the compound R2, the skim layers of the working layers being made of the compounds 1 to 5.

A fourth series of tires S4 in accordance with the invention (FIG. 3) was prepared with layers C1, C2, C3 made of the compounds 1 to 5, the skim layers of the working layers also being made of the compounds 1 to 5. Some tires of this series S2 were prepared with identical compounds for the layers C1, C2, C3 and the skim layers of the working layers and others with different compounds.

The results of the measurements are shown in the following table; they are expressed in kg/t, a value of 100 being assigned to the tire T1.

| Tire T1 | Tire S1 | Tire S2 | Tire S3 | Tire S4 |
|---|---|---|---|---|
| 100 | 100 | 99 | 97 | 96 |

1. A tire with a radial carcass reinforcement for a vehicle of the heavy duty type comprising a crown reinforcement comprising at least three working crown layers of reinforcing elements, crossed from one layer to the other, making with the circumferential direction angles of between 10° and 45°, which is itself capped radially by a tread, said tread being connected to two beads by two sidewalls, at least two layers of rubber compound being arranged between the ends of said at least three working crown layers, wherein, in a meridian plane, the thickness of said at least three working crown layers, measured in the equatorial plane, is less than 5 mm, wherein the reinforcing elements of said at least three working crown layers are individual metal wires of diameter less than 0.50 mm, wherein the distance between the reinforcing elements, measured along the normal to the direction of the mean line of the wire, is strictly less than 1 mm, wherein the axial width of each of said at least three working crown layers is greater than 60% of the axial width of the tread, wherein at least a distance dᵢ between two working layers separated by a layer of rubber compound and measured at the end of the axially narrowest working layer in contact with it is such that 0.5<dᵢ<2.5 mm, and wherein, in a meridian plane, the thickness of at least one layer of rubber compound is substantially constant over the axial width comprised between the axially inner end of one layer of rubber compound and the end of the axially narrowest working layer in contact therewith.

2. The tire according to claim 1, wherein the diameter of the individual metal wires of said at least three working crown layers is greater than or equal to 0.25 mm.

3. The tire according to claim 1, a working crown layer of reinforcing elements comprising two skim layers between which the reinforcing elements are positioned, wherein the skim thickness measured in a radial direction on each side of a reinforcing element is less than 0.30 mm.

4. The tire according to claim 1, wherein the stiffness per unit width of each of the working crown layers is comprised between 35 and 70 daN/mm.

5. The tire according to claim 1, wherein the crown reinforcement comprises four working crown layers of reinforcing elements and wherein three layers of rubber compound are respectively arranged between the ends of said four working crown layers.

6. The tire according to claim 5, wherein the distance dᵢ between two working layers separated by one of the three layers of rubber compound and measured at the end of the axially narrowest working layer in contact therewith is such that 0.5<dᵢ<2 mm and wherein, in a meridian plane, the thickness of each of the three layers of rubber compound is substantially constant over the axial width comprised between its axially inner end and the end of the axially narrowest working layer in contact therewith.

7. The tire according to claim 1, wherein the tensile modulus of elasticity at 10% elongation of at least one layer is less than 8 MPa and wherein the maximum value of tan(δ), denoted tan(δ)ₘₐₓ, of the at least one layer is less than 0.100.

8. The tire according to claim 7, wherein said at least one layer of rubber compound is an elastomeric compound based on natural rubber or on synthetic polyisoprene with a majority of cis-1,4 chains, and possibly on at least one other diene elastomer, the natural rubber or the synthetic polyisoprene in the case of a blend being present in a majority proportion relative to the proportion of the other diene elastomer or elastomers used, and on a reinforcing filler composed:
a) either of carbon black with a BET specific surface of greater than 60 m²/g,
i. used at a content of between 20 and 40 phr when the oil absorption number (COAN) of the carbon black is greater than 85,
ii. used at a content of between 20 and 60 phr when the oil absorption number (COAN) of the carbon black is less than 85,
b) or of carbon black with a BET specific surface of less than 60 m²/g, whatever its oil absorption number, employed at a content of between 20 and 80 phr and preferably between 30 and 50 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 30 and 260 m²/g, employed at a content of between 20 and 80 phr and preferably between 30 and 50 phr,
d) or of a blend of carbon black described in (a) and/or of carbon black described in (b) and/or a white filler described in (c), in which the overall content of filler is between 20 and 80 phr and preferably between 40 and 60 phr.

9. The tire according to claim 1, said at least three working crown layers each being formed of reinforcing elements inserted between two skim layers of rubber compound, wherein the tensile modulus of elasticity at 10% elongation of at least one skim layer of at least one working crown layer is less than 8.5 MPa and wherein the maximum value of tan(δ), denoted tan(δ)ₘₐₓ, of said at least one skim layer of at least one working crown layer is less than 0.100.

10. The tire according to claim 9, wherein said at least one skim layer of at least one working crown layer is an elastomeric compound based on natural rubber or on synthetic polyisoprene with a majority of cis-1,4 chains, and possibly on at least one other diene elastomer, the natural rubber or the synthetic polyisoprene in the case of a blend being present in a majority proportion relative to the proportion of the other diene elastomer or elastomers used, and on a reinforcing filler composed:
a) either of carbon black with a BET specific surface of greater than 60 m²/g,
i. used at a content of between 20 and 40 phr when the oil absorption number (COAN) of the carbon black is greater than 85,
ii. used at a content of between 20 and 60 phr when the oil absorption number (COAN) of the carbon black is less than 85,
b) or of carbon black with a BET specific surface of less than 60 m²/g, whatever its oil absorption number, employed at a content of between 20 and 80 phr and preferably between 30 and 50 phr,
c) or of a white filler of silica and/or alumina type comprising SiOH and/or AlOH surface functional groups, selected from the group consisting of precipitated or fumed silicas, aluminas and aluminosilicates, or alternatively carbon blacks modified during or after the synthesis having a BET specific surface of between 30 and 260 m²/g, employed at a content of between 20 and 80 phr and preferably between 30 and 50 phr,
d) or of a blend of carbon black described in (a) and/or of carbon black described in (b) and/or a white filler described in (c), in which the overall content of filler is between 20 and 80 phr and preferably between 40 and 60 phr.

11. The tire according to claim 1, wherein the crown reinforcement is supplemented by a layer of circumferential reinforcing elements.

12. The tire according to claim 11, wherein the layer of circumferential reinforcing elements is radially positioned between two working crown layers.

13. The tire according to claim 11, wherein the reinforcing elements of at least one layer of circumferential reinforcing elements are metallic reinforcing elements having a secant modulus at 0.7% elongation in the range from 10 to 120 GPa and a maximum tangent modulus of less than 150 GPa.

14. The tire according to claim 1, wherein the crown reinforcement is supplemented radially on the outside by at least one additional ply, referred to as a protective ply, of reinforcing elements which are oriented with respect to the circumferential direction at an angle of between 10° and 45° and in the same direction as the angle formed by the reinforcing elements of the working crown layer radially adjacent to it.
